(19) United States
(12) Patent Application Publication
(10) Pub. No.: US 2022/0108014 A1
(43) Pub. Date: Apr. 7, 2022

(54) GROUP ATTESTATIONS

(71) Applicant: Hewlett-Packard Development Company, L.P., Spring, TX (US)

(72) Inventors: Joshua Serratelli Schiffman, Bristol (GB); Thalia Laing, Bristol (GB); Gaetan Wattiau, Bristol (GB)

(73) Assignee: Hewlett-Packard Development Company, L.P., Spring, TX (US)

(21) Appl. No.: 17/414,488

(22) PCT Filed: Jun. 26, 2019
(86) PCT No.: PCT/US2019/039177

§ 371 Date: Jun. 16, 2021

(51) Int. Cl. G06F 21/57

(52) U.S. Cl. CPC G06F 21/57; G06F 2221/034

(57) ABSTRACT

In an example, a method includes requesting, from a node associated with a group comprising a plurality of computing devices associated with an access structure defining a set within the group of computing devices, an attestation of a capability of the set; receiving the attestation; and implementing, based on the received attestation, a procedure according to a device capability policy.

### BACKGROUND

A remote party may interact with a device as part of a procedure to determine information about the device. During this interaction, the remote party may seek to establish the capabilities of the device. In this regard, the device may attest to its capabilities so that the remote party can determine the device capabilities.

### BRIEF DESCRIPTION OF DRAWINGS

Non-limiting examples will now be described with reference to the accompanying drawings, in which:

FIG. 1 is a flowchart of an example method involving attestation;

FIG. 2 is a schematic illustration of an example scenario involving attestation;

FIGS. 3 to 5 are schematic illustrations of example scenarios involving attestation;

FIGS. 6 and 7 are flowcharts of example methods involving attestation;

FIG. 8 is a simplified schematic illustration of an example apparatus for providing an attestation; and

FIG. 9 is a simplified schematic illustration of an example machine-readable medium associated with a processor.

### DETAILED DESCRIPTION

In some examples, a user may have a number of devices (for example, computing devices) which may be involved in an interaction with a remote party such as a service provider or requesting entity (which may, for example, be associated with a network node such as a server). The remote party may wish to be informed about the capabilities of the devices. These capabilities may be indicative of a functionality of the device (e.g., how the device is expected to behave, which may be related to its hardware and/or software components).

In some examples, once the remote party has been informed of the capabilities of the devices, the remote party may make a decision based on the informed capabilities.

For example, the remote party may perform a procedure once it has been informed of the capabilities of the devices. Examples of such procedures include: providing power (e.g., to devices with certain power consumption specifications), performing physical actions on behalf of a service (e.g., operation of a smart light may depend on its specified capabilities), data collection (e.g., a sensor such as a temperature gauge may have certain capabilities and these capabilities may be relevant for the purpose of accurate reporting of data to a service), automation (e.g., at home or elsewhere where a service may wish to be informed of the capabilities of the device providing the automation), digital rights management (e.g., a service may wish to establish which devices can use certain digital rights based on the device capabilities) and user authentication (as explained in more detail in the following example).

In an example, the remote party may be a service provider specifying that a certain degree of trust is to be established in order to provide a service for the user. For example, the service provider may specify that a certain authentication procedure is to be performed with respect to one or more of the devices. Therefore, the service provider may wish to establish whether the device(s) have certain physical properties or capabilities, which may be indicative of what kind of authentication can be performed using the device(s).

Examples of capabilities which may be provided by the devices may include, for example, a hardware functionality and/or a software functionality (e.g., a video camera, a secure key storage, a cryptographic coprocessor, or a physical user identifier such as a button to indicate user presence at the device), a biometric identification system (e.g., any of a fingerprint scanner, a facial recognition capability, a voice recognition capability or the like), a password verification system or the presentation of secure data for example in the form of a hardware dongle or keycard. In an example, multi-factor authentication involves the use of several devices to establish user access to the service and those devices may have different capabilities in terms of user authentication. In some examples, it may be intended to provide a service to a set of devices assuming that group is capable of providing a suitable level or type of authentication/authorization.

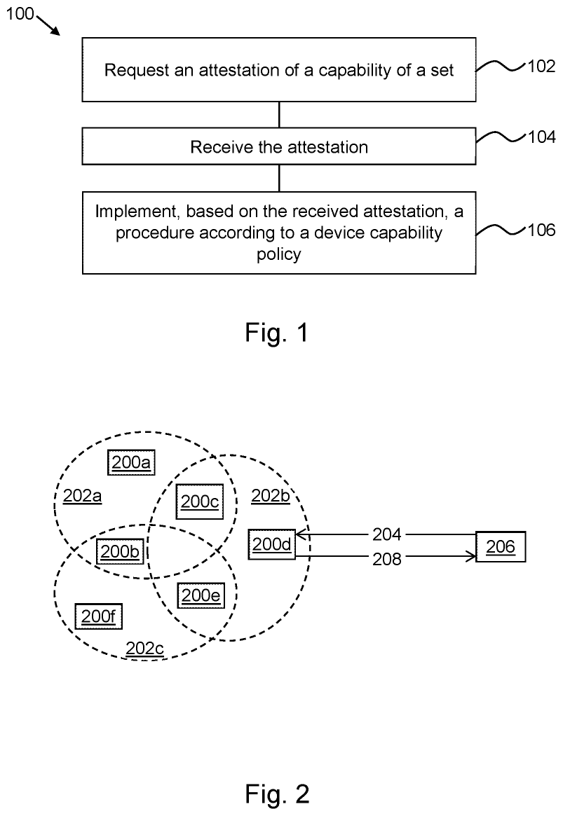

FIG. 1 depicts a flowchart of a method 100, which may be implemented by a network node such as a server associated with a remote party such as a service provider. As explained previously, a remote party may make a decision based on a device capability. The following examples refer primarily to the use case of user authentication. However, as made clear above and as will be apparent from the following description, methods, machine-readable mediums and apparatus described herein may have utility for various purposes beyond user authentication.

The method 100 comprises, in block 102, requesting, from a node associated with a group comprising a plurality of computing devices associated with an access structure defining a set (e.g., an authorized set) within the group of computing devices, an attestation (or declaration) of a capability (e.g., a user authentication capability) of the set. The capability may comprise a hardware capability.

An ‘access structure’ may define at least one set of devices that are authorized (e.g., by a user) to act together on behalf of the group as a single logical device for a remote party. In some examples, the access structure identifies the possible combination(s) of devices that could form a logical device (e.g., a single logical device) to interact with the remote party. Each possible combination of devices within the access structure has a set of at least one capability, which is also therefore possessed by the logical device. Thus, in some examples, the user may create the access structure and present the access structure to the remote party. The remote party can then decide whether or not every possible logical device would satisfy a device capability policy, DCP. In other examples, the remote party may determine the sets.

The node may be representative of a logical device comprising the set. For example, the set may comprise several devices with certain capabilities, and the node may represent the set in the form of a logical device when interacting with a remote party.

A ‘DCP’ describes the specified capabilities of the logical device for allowing the logical device to interact with a remote party. A DCP may be empty, which may indicate that any possible device with any capabilities can interact with the remote party. In another example, the DCP may specify capabilities for allowing the logical device to interact with the remote party, for example, depending on how strict the remote party is (i.e., the remote party may interact with the logical device if the devices have certain capabilities and not interact with the logical device if the devices do not have those certain capabilities).

In some examples, the user may receive the DCP from a remote party and decide to construct an access structure to comply with the DCP. In some examples, a remote party may construct the access structure for the user, given a particular service provider's DCP.

In some examples, an access structure describes a list of sets (of devices) to facilitate an interaction with a resource such as a service provided by a service provider. The access structure may not provide any indication as to why it has been constructed in a particular way; merely, it may describe which sets are authorized.

Following from the above example, an access structure Γ may describe a list of sets which may be authorized by a user. In some examples, this could be defined by a number of devices. For example, an access structure may be a threshold access structure which specifies that, in a group of n devices, the service can be accessed if at least t devices of the group participate in a procedure such as authentication (and otherwise, access will not be allowed and/or the procedure may not be implemented), and in such an example, the threshold access structure Γ consists of all the subsets of the n devices of size greater than or equal to t. In an example, a user may select an access structure comprising two disjoint sets of devices where each set may imply that different capabilities are provided by each set. For example, for the group of devices denoted D1, D2 and D3, an access structure could be defined by {{D1, D2}, {D3}} where either the combination of D1 and D2 may facilitate a certain procedure, or D3 alone may facilitate the procedure. A possible reason for a user selecting such a structure may be if D3 is considered to be a strong/trustworthy device (for example, it may have a robust user authentication capability such as a biometric identification system) without any additional device being involved to facilitate the procedure. While the capabilities of D1 and D2 may be weaker, these may be collectively sufficient to provide a satisfactory level of trustworthiness. As will be discussed in greater detail below, in some examples the node may have knowledge of the access structure and/or the composition of at least one set but this may not be the case in all examples.

Although an access structure may be defined (e.g., by the user), this does not necessarily imply that the procedure will be facilitated (e.g., to provide access to a service). Rather, depending on its DCP, a remote party may consider whether or not the access structure is acceptable (e.g., in the case of the group D1, D2, D3 described above, a remote party may not consider the capabilities provided by the set comprising only D3 as being acceptable according to its DCP).

In some usages, the term ‘attestation’ may be used to refer to a declaration of the software running on the device. However, the term is used herein to refer specifically to a declaration of a device capability (e.g., an authentication capability, hardware type such as a video camera (and its corresponding operating capabilities such as its resolution, frame rate, etc.), a secure key storage, cryptographic coprocessor, a physical user identifier such as a button to indicate user presence at the device). An attestation of a capability may be regarded as a statement by a key holder (e.g., a device certified to make such statements) that the totality of hardware, software and corresponding configurations provides a guarantee of the integrity of the stated capability. In other similar words, the attestation may provide evidence that the device will have this capability in the future whether or not some external factor such as a device system restart occurs. In some examples, the device may have or indicate that it has a capability for a specified period of time. In this scenario, a rule may be specified (e.g., to be implemented by the remote party) such that the device's capability is to be re-established before, once or after the specified period of time has expired so that the remote party may be able to take appropriate action. In another example, the attestation may have a validity period which is determined or set by the remote party. For example, before, once or after the specified period of time has expired, the remote party may request an attestation from the client node (e.g., the device itself or another client node communicatively coupled to the device) or the client node may itself cause an attestation to be provided. Based on the knowledge that an attestation is valid for a specified period of time, the remote party may be obliged to determine whether or not the device still has its previously-attested capability and/or specify that the device's provisioned credentials are to be refreshed for verification purposes at an appropriate time.

In some examples, the attestation is an explicit declaration of a device capability (rather than, for example, a declaration of a software version from which capabilities may be implicitly derivable). In some examples, the attestation is a declaration of a hardware capability.

In some examples, the attestation may be cryptographically signed.

As is set out in greater detail below, the attestation may comprise an attestation of the capabilities of at least one set of the access structure. In some examples, the attestation may comprise capabilities of each set (e.g., the attestation may comprise an intersection of the capabilities of the union of all sets). In other examples, the group (or a device thereof) may declare its capabilities and a receiving entity may define the access structure and/or the sets based on these capabilities. In some examples, the node (which may comprise, for example, a client-side node) may be implemented by one of the computing devices, or a plurality of the computing devices may individually or collectively act as a single logical device (e.g. a virtual device acting as the node). Thus a single device (or single virtual device) may, in some examples, provide the attestation on behalf of the group. The computing device(s) acting as the node may be communicatively coupled to the other computer devices within the set or the group, for example, to obtain information regarding the capabilities of the other computing devices.

To consider a particular example, a first device (e.g., one of the plurality of computing devices) may comprise a dongle, which may be connected to a second device (e.g., another one of the plurality of computing devices) comprising a laptop via a communication port of the laptop. In such an example, an interface of the laptop may provide a capability such as a password verification system (which may be an example of a user authentication capability) while the dongle may store a security key (e.g., another user authentication capability) which, when connected to the laptop, may allow the laptop (which may represent the node) to attest to the collective capabilities provided by the laptop and the dongle. The node may be any other logical point communicatively coupled to the authorized set or the group.

In some examples, the capability may be a user authentication capability.

In some examples, the capability may comprise a plurality of capabilities.

In some examples, each of the computing devices may provide at least one capability and these capabilities may be the same or different to each other.

The access structure may comprise a plurality of sets (e.g., authorized sets) where each set may comprise a different combination of computing devices. Accordingly, each set may have different capabilities. In some examples, the capabilities may be provided by hardware modules and/or software modules of the devices(s) which can contribute to authorizing or implementing a procedure such as user authentication.

Examples of computing devices which may form part of a group may include, for example, a client or user terminal, smart phone, tablet, smart card, dongle, laptop, personal computer, Internet of Things (IoT) device, or any other device capable of providing user authentication. Examples of capabilities/facilities may include, for example, a hardware module, a software module, a biometric identification system, password verification system, security token, private key, or any other authentication system capable of being provided by the device or through implied possession of the device.

The method 100 further comprises, in block 104, receiving the attestation for example at a server or the like. For example, a network node (e.g., a server) associated with the service may be communicatively coupled to the ‘client’ node associated with the set or the group in order to receive the attestation therefrom. The attestation may comprise, for example, an explicit list of the hardware and/or software authentication capabilities of the group or at least one set within the group.

The method 100, further comprises, in block 106, implementing, based on the received attestation, a procedure according to a device capability policy, DCP. For example, the procedure may comprise determining a service authorization level for the group of computing devices based on the received attestation. The DCP may be associated with the service authorization level where a certain device capability may be linked to a certain service authorization level. The service authorization level, which may be an example of a trust level, may refer to whether a particular set may access a particular service provided by the remote party. In some examples, the DCP may indicate what procedure may be implemented based on the attested capabilities of the devices (e.g., what service authorization level may be authorized given the attested capabilities). For example, where the attestation comprises an indication of a user authentication capability of the group of devices, the method 100 may further comprise determining a service authorization level for the group of devices based on the received attestation.

By obtaining the attestation, a remote party can decide whether—and to what extent—the group of devices, or a set selected therefrom, can be trusted based on their capabilities (or more generally, a remote party can decide what services may be appropriately provided thereto). In other words, the method of FIG. 1 allows a “group attestation” of the combination of capabilities of the group, or set, of devices.

In some examples, the remote party can implement certain procedures based on the DCP responsive to the received attestation. For example, the DCP may be indicative of a specified procedure to be implemented based on a minimum capability of the set (e.g., the remote party may expect the set to have the minimum capability in order to implement the specific procedure). Implementing the procedure may comprise determining a service level based on a comparison between the received attestation and the device capability policy. For example, the device capability policy may list certain capabilities as being acceptable for specified service levels and, upon receiving the attestation, the remote party may compare the attestation with its list of capabilities to decide what service level is to be established or provided.

Methods and apparatus described herein may provide some flexibility in terms of the devices that can be presented by a user to allow a remote party to determine whether or not to trust or authorize the set. In examples relating to authentication, the role of authentication may be spread throughout the group of devices, which may be formed into more than one authorized set (which sets may overlap). In some examples, a user may not always have access to every single device within a group of devices. However, the user may still be able to access the service providing the device(s) that are accessible to the user have the specified capabilities according to the DCP. For example, in the absence of a finger print reader, presentation of a dongle and a code sent as a text message to a user's phone may be accepted for an authorization procedure. Depending on the trust level that can be established based on the capabilities in a particular authorized set, access to a particular service may be permitted, restricted or denied in some examples. Accordingly, there may be some flexibility for the user in terms of which devices need to be presented so that an authentication system for a service provider can provide services depending on which devices are available. In some examples, a user may receive an indication that access to a particular service or service level may depend on which device(s) the user can present to the service.

The above examples relate to user authentication. However, the examples may also be applicable to other purposes such as providing power, performing physical actions on behalf of a service, data collection, automation, digital rights management, among other purposes.

In a further example of how a device may interact with a remote party such as a service provider to facilitate implementation of a procedure, a smartcard may be used to authenticate a user (i.e., to facilitate the procedure). In this example, the user initially registers the smartcard with a service provider before it is provisioned for use as an authentication device. Attestation can be used to prove to the service provider that the smartcard is a trustworthy device for the purpose of authentication. Once approved, the smartcard can perform authentication with the service, potentially repeatedly into the future without the need for additional attestations if the attestation guarantees long-term integrity of the device. In some examples, the capability of the device may be re-established after a specified period of time (e.g., to determine whether or not the capability has changed). For example, a device may comprise a fingerprint reader and the device may attest to having a certain firmware version. The device firmware may be updatable such that the remote party may wish to check (e.g., by requesting an attestation) after a specified period of time (e.g., every 6 months) that the device still has the latest firmware version. If the device fails to satisfy this check, the remote party could revoke the device's credentials for being trusted to perform an authentication procedure such as fingerprint scanning and/or provide an indication that the latest firmware version is to be installed before the device can be trusted to perform the authentication procedure.

FIG. 2 schematically illustrates an example scenario where there are a plurality of computing devices 200a-f attesting to their capabilities. Although not explicitly shown in FIG. 2, the computing devices 200a-f may be communicatively coupled to each other. An access structure defines a plurality of sets (e.g., authorized sets) 202a-c depicted by dashed lines where each set 202a-c comprises a different combination of computing devices 200a-f. Although not shown in the diagram, the unions of the sets 202a-c also define sets. In an example use scenario, one of the computing devices (in this example, computing device 200d) represents a client-side node for receiving a request 204, from a network node 206 (e.g., a server-side node such as a server associated with a service provider), to attest to a capability of the computing devices 200a-f. In response, the computing device 200d determines the capabilities of the computing devices 200a-f. The computing device 200d then sends a response 208 (i.e., an attestation) to the network node 206 to attest to the capabilities of the computing devices 200a-f. This response 208 may be indicative that the computing devices 200a-f are co-operatively related to each other. A remote party associated with network node 206 can then implement a procedure according to the DCP. In some examples where the capability comprises a user authentication capability, the procedure may involve establishing a service authorization level for the computing devices 200a-f based on the received attestation. For example, the service provider may establish different service authorization levels for the different authorized sets 202a-c based on the particular user authentication capabilities of the computing devices 200a-f within each set 202a-c.

In some examples, the service provider may define the sets following an attestation. In other examples, the devices may themselves define the sets. Examples in this regard are set out in greater detail below. However, briefly, in some examples, the sets may be defined on the basis that the devices of the set together embody a threshold quality. For example, a threshold may be threshold number of devices. In such examples, the attestation may comprise the capabilities of each of the sets, the intersection of the capabilities of the sets, the capability of set having the lowest ranked capability, or the like. The network node 206 may determine if the attestation can satisfy its threshold for providing the service.

In other examples, the devices may attest to their capabilities and the sets may be determined based thereon, for example by the network node 206. For example, a threshold may be a qualifying capability level such as a qualifying authentication capability, where there may be more than one qualifying capability level in some examples. The network node may define the sets once the capabilities are known, and may for example notify the user of the sets. For example, the user may be notified that any of the authorized sets 202a-c may be used to access a service, but all devices of a set must be present to provide the service.

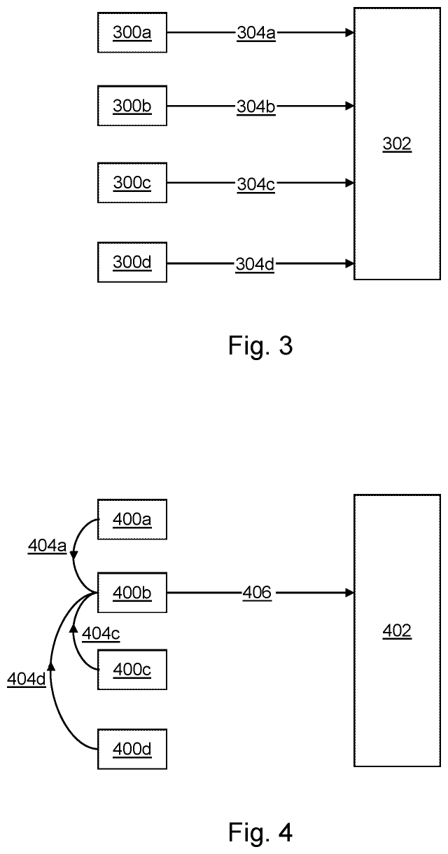

FIGS. 3 to 5 show different examples of how attestation may occur.

FIG. 3 is a schematic illustration of an example scenario where there is a plurality of computing devices 300a-d. Upon receiving the request as described above, the individual computing devices 300a-d may individually attest to their capabilities and provide an indication of the group of devices of which they are a member. In the figure, the individual attestations are depicted as individual arrows 304a-d from the respective computing devices 300a-d. A remote party 302 communicatively coupled to each of the computing devices 300a-d may then implement a procedure based on the plurality of received attestations 304a-d, which in this example, are individual attestations from each of the computing devices 300a-d. The attestations 304a-d may comprise information that binds the statement of each device's capabilities to cryptographic material used in the procedure that the group is performing with respect to the remote party. For example, a user may provide a group ID to the devices which is included in the attestation(s) 304a-d to indicate that these devices are acting together (i.e., they are co-operatively associated with each other). The group ID may be associated with the group's access structure. In some examples, each attestation 304a-d may be signed or encrypted using a key of the computing device 300a-d from which it originates. Accordingly, the remote party 302 may obtain information regarding the capabilities of each of the computing devices 300a-d from the attestation, as well as potentially being able to obtain the identity of each of the computing devices 300a-d and their individual capabilities from the attestation. Information regarding the capabilities may be conveyed by the attestation in the form of an indicator or Universal Resource Identifier (URI) to more complete information about the capability. As mentioned above, an access structure is defined. However, in an example, the computing devices 300a-d may not necessarily have any knowledge of the access structure or the sets. Instead, the remote party 302 may determine or be informed of the access structure, and based on the received attestations, can determine the procedure to be implemented accordingly.

FIG. 4 is a schematic illustration of an example scenario where there are a plurality of computing devices 400a-d and a remote party 402. In this example, one of the plurality of computing devices 400a-d (in this example, computing device 400b) interacts with the rest of the group of computing devices 400a,c,d to obtain information regarding the capabilities of the rest of the group. To obtain this information, the computing device 400b is communicatively coupled with the rest of the group of computing devices 400a,c,d. Prior to or upon being caused to produce an attestation, each of the rest of the group of computing devices 400a,c,d attests to their individual capabilities, as indicated by arrows (i.e., attestations 404a,c,d provided respectively by the computing devices 400a,c,d) which are received by the computing device 400b. Based on the received attestations 404a,c,d, the computing device 400b then sends a statement (i.e., an attestation 406) to the remote party 402 describing the capabilities of the group as a whole, where the attestation 406 also comprises the capabilities of the computing device 400b itself. As with the example of FIG. 3, the group of computing devices 400a-d may not necessarily have knowledge of the access structure or the sets. In some examples, the attestation 406 may be signed or encrypted using a key of computing device 400b from which it originates, and/or the attestations 404a, c, d from each device may be signed or encrypted using a key of computing device 400a,c,d from which it originates. In some examples, the computing device 400b may send only some of the capabilities of the group.

In contrast with the example of FIG. 3, the remote party 402 may not be able to obtain the identity of each of the computing devices 400a-d and their individual capabilities. A greater degree of privacy may be afforded to the user and/or the computing devices 400a-d since the remote party 402 may be able to identify a list of capabilities of the group as a whole without being able to attribute specific capabilities to individual computing devices 400a-d.

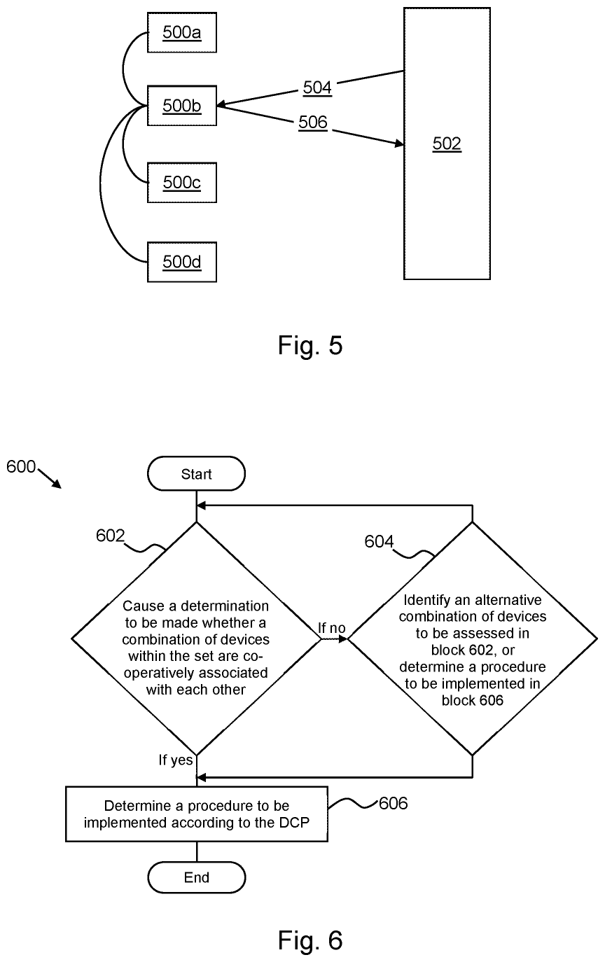

FIG. 5 is a schematic illustration of an example scenario where there are a plurality of computing devices 500a-d and a remote party 502. In this example, one of the group of computing devices 500a-d takes on the role of group controller (in this example, computing device 500b). In this example, the role of the group controller is to determine the authorized set(s) (e.g., for the access structure) based on a policy 504 (e.g., received from the remote party 502 or set by a user) as well as declaring the capabilities (i.e., with attestation 506) of these authorized set(s) to the remote party 502. Similar to the example of FIG. 4, the group controller is communicatively coupled to the rest of the group of computing devices 500a,c,d to obtain information regarding their capabilities. In some examples, the computing device 500b may send only some of the capabilities of the group/sets once determined.

As described in more detail herein, there may be a number of different procedures for determining which combinations of the computing devices 500a-d might be authorized according to the DCP of the remote party 502 and what specific capabilities are provided by these set(s). In some examples, the access structure may be determined according to a threshold (e.g., a threshold policy defined by a user) specifying a minimum capability for a combination of computing devices selected from the group. The devices providing the minimum capability may be defined as a set. As described in more detail below, a threshold policy may be defined for specifying a minimum authentication specification for a combination of computing devices forming an authorized set. The role of the group controller may, compared with the example of FIGS. 3 and 4, provide a greater degree of privacy for the user or computing devices 500a-d since there may not be a need to attest to the capabilities of the group of computing devices 500a-d as a whole. For example, the group controller may only declare the capabilities of certain devices 500a-d in the group and/or provide information regarding one or more set(s) instead of providing information regarding all the individual capabilities of the group as a whole.

In some examples, the set(s) may be defined by the user or a remote party (e.g., the set(s) may be predetermined according to a user's preference or according to some policy set by the remote party) or may otherwise be determined by the user or remote party (e.g., in response to the received attestation(s) and/or in accordance with the DCP or a user's preference). In the example of FIG. 5, the set(s) may be determined by the group controller, for example, in response to a policy (which may be received from the remote party). In some examples, each computing device may attest to its capabilities so that, in some cases, there may be a duplication in terms of the capabilities within a particular set.

As mentioned above, in some examples which relate to user authentication, the service authorization level for different authorized sets of computing devices within the group may be set according to a minimum capability such as a minimum user authentication capability within each set of computing devices. Depending on the user authentication capability within a set, access to a service may be provided at a certain service authorization level if the user authenticates their identity using the authorized set.

As mentioned above, in some examples, the access structure may be determined according to a threshold policy specifying a minimum authentication specification for a combination of computing devices selected from the group. A particular combination of computing devices may refer to a particular authorized set so that where there are different combinations of computing devices that comply with the threshold policy, there may be a plurality of authorized sets. The minimum authentication specification may comprise a minimum number of computing devices and/or a combination of user authentication capabilities provided by the computing devices that are sufficient for complying with the threshold policy. For example, a user, the computing devices or a service provider may establish the threshold policy according to the type of service being requested/provided. For example, a financial transaction service provider may specify a user authentication capability with which a higher degree of trust can be established than, for example, a video streaming service provider. As such, the access structure defined for the financial transaction service may define a minimum number of computing devices (e.g., three or more) within each authorized set and/or a minimum user authentication capability (e.g., multi-factor authentication) within each authorized set to comply with the threshold policy. In contrast, the access structure defined for the video streaming service may define a lower minimum number of computing devices (e.g., one or more) and/or a lower-ranked minimum user authentication capability (e.g., a password verification system) within each authorized set to comply with the threshold policy.

In an example, a user may have access to a group of five computing devices denoted {d1, d2, d3, d4, d5}. The user, the computing devices or the service provider may identify an access structure, Γ, comprising authorized sets selected from the group of computing devices. In an example where the group of computing devices interacting with the service provider is always the same (i.e., every device is always present), the access structure Γ may be equal to the group {d1, d2, d3, d4, d5}.

However, different sets of devices may be authorized to access the service. In such examples, various different combinations of the computing devices within the group may be used for authorizing access to the service. As part of the attestation procedure, the authorized set(s) may co-operate to act as a single device. For example, based on the group of computing devices, the access structure, Γ, could be defined as Γ={{d1}, {d2, d3}, {d4, d5}}, meaning that either d1, or d2 and d3, or d4 and d5 can co-operate and act as a single device when interacting with the remote party.

In some examples, the access structure Γ may be defined by a threshold policy that specifies that a minimum of t out of n computing devices are specified to implement a procedure such as accessing a service provided by a service provider. Thus, in such examples, the access structure Γ consists of all sets of size greater than or equal to t. In such examples,Γ may be regarded as a threshold access structure with n devices and a threshold of t. In an example, if there are five devices {d1, d2, d3, d4, d5} as before, an example threshold access structure where t=3 may beΓ={{d1, d2, d3}, {d1, d2, d4}, {d1, d2, d5}, {d1, d3, d4}, {d1, d3, d5}, {d1, d4, d5}, {d2, d3, d4}, {d2, d3, d5}, {d2, d4, d5}, {d3, d4, d5}, {d1, d2, d3, d4}, {d1, d2, d3, d5}, {d1, d2, d4, d5}, {d1, d3, d4, d5}, {d2, d3, d4, d5}, {d1, d2, d3, d4, d5}}. Based on this example, minimal sets (e.g., minimal authorized sets) may be defined based on the smallest sets (i.e., the sets with the minimum number of computing devices). In the above example, the minimal set isΓ={{d1, d2, d3}, {d1, d2, d4}, {d1, d2, d5}, {d1, d3, d4}, {d1, d3, d5}, {d1, d4, d5}, {d2, d3, d4}, {d2, d3, d5}, {d2, d4, d5}, {d3, d4, d5}}. Thus, in this example, a user may need just one of the sets selected from minimal set in order to access the service and/or for the procedure to be implemented.

In some examples, and as depicted by FIG. 6, a method 600, which may be implemented as part of or in conjunction with the method 100 of FIG. 1, comprises, in block 602, causing a determination to be made as to whether a combination of devices within the set are co-operatively associated with each other, for example, to provide the attestation with proof of the capability of the combination of devices within the set associated with the node. For example, devices may be co-operatively associated with each other if the user has those devices in their possession and/or if those devices are communicatively coupled to each other. Upon a determination being made that the combination of devices are not co-operatively associated with each other (i.e., “if no” is the response to block 602), the method 600 may further comprise, in block 604, identifying an alternative combination of devices to be assessed by block 602, or, in block 606, determining a procedure to be implemented according to the DCP (e.g., in examples relating to user authorization, the procedure may comprise determining the service authorization level for the combination of devices accordingly). Upon a determination being made that the combination of devices are co-operatively associated with each other (i.e., “if yes” is the response to block 602), the method 600 may further comprise block 606, i.e., determining the procedure to be implemented.

An attestation of the capabilities of a group of devices may be indicative of the devices having a co-operative relationship, for example, for the same purpose (e.g., to verify a user or device identity for a particular service). For example, the attestation may be indicative that the devices are known to each other or that the devices are co-operatively related to each other. In some examples, knowledge that certain devices are in a co-operative relationship may be used to verify the collective capabilities of the attesting devices, which may be used to establish a degree of trust in the attesting devices (e.g., for the purpose of implementing a procedure such as setting a service authorization level). By attesting to the capabilities of the group while also verifying that the devices have a co-operative relationship may allow a degree of trust to be established which might otherwise not be possible for a group of devices without such a co-operative relationship.

An attestation of the capabilities of a group may simplify the process for allowing a remote party to determine whether the group of devices can be trusted and/or that the collective capabilities of the group can be verified. A user may be afforded flexibility and/or reduced burden in terms of selecting which devices to use for accessing a service while still allowing the remote party to trust the devices the user selects or has available for accessing the service/implementing the procedure. Such techniques may be useful in multi-device based user authentication (MBDA) scenarios, for example.

In some examples, which may be related to at least the example scenario depicted by FIG. 3 and as described above, the method 600 may comprise causing each of the devices within the set(s) or the group to indicate, responsive to receiving a common challenge, that the combination of devices are co-operatively associated with each other. For example, a network node such as a server associated with a remote party may send the common challenge to the computing devices within the set whereupon each of the computing devices may respond by attesting to their individual capabilities. Such a response may indicate that the computing devices within the set are co-operatively associated with each other. In an example, the responses from each computing device may, when combined, provide confirmation that the computing devices within the set are co-operatively associated with each other.

The response, or attestation, may comprise information regarding the individual capabilities of the computing devices such as an identity of a hardware module communicatively coupled to the node. The response, or attestation, may be signed by each of the computing devices within a particular set or group of computing devices (i.e. in some examples, the capabilities of device A are declared and signed by device A, the capabilities of device B are declared and signed by device B, etc.). The response, or attestation, may comprise information about the computing devices such as a group name, an identity of the computing devices within a particular set or group, and an access structure for the service. In some examples, each computing device may obtain information regarding the access structure by, for example, a single computing device broadcasting the access structure, receiving the information from a third party device (e.g., a relying party) not within the group, or the computing devices agreeing on the access structure in a distributed manner.

In some examples of the method 600, which may be related to at least the example scenario depicted by FIG. 4 and as described above, causing the determination to be made may comprise causing a first device of the combination of devices to provide, responsive to a statement generated by a second, different, device of the combination of devices attesting to a capability (e.g., a user authentication capability) of the second device, an indication that the first device has signed the statement from the second device (i.e., in some examples, the capabilities of device A are declared by device A, the capabilities of device A are then received by device B, which itself declares its own capabilities and signs off on the declaration provided by device A, and this combined statement of A's signed capabilities, as well as B's capabilities may be sent to the service provider, or may be sent to another device C for signing off if there are more than two devices). In some examples and similar to the above example related to FIG. 3, information may be provided to the remote party regarding the individual capabilities of the plurality of computing devices. In some examples, the computing devices may produce an attestation which lists all the capabilities of all the computing devices within a particular set or the group. In some examples, each computing device may sign the same statement (e.g., response or attestation) using their own key. For example, each device may sign the statement with an individual manufacturer or self-generated key, or using a group key, which may be a key distributed amongst the set or group such that only an authorized set of computing devices can produce a valid signature, for example.

In some examples of the method 600 (which may be related to at least the example scenario depicted by FIG. 5 in some variations) and as described above, causing the determination to be made may comprise causing the combination of devices to collaboratively produce a statement attesting to the capability of (e.g., each of) the combination of devices. In some examples, one of the computing devices may take the role of a group controller for coordinating the response/attestation to be sent to the service provider after receiving the capabilities from the other computing devices, and in some examples, this response/attestation may comprise only selected information regarding e.g., the capabilities of a set, for example. By collaboratively producing the statement, a degree of privacy may be afforded since the statement may not necessarily include information identifying each computing device. For example, the network node associated with a remote party may not be able to learn the individual capabilities of each device in the group and/or may not be able to link an individual signature produced by a given computing device to the particular capabilities of that computing device. Rather, in use, the node may attest to the capabilities of the set or group of devices as a whole instead of each individual computing device attesting to their individual capabilities.

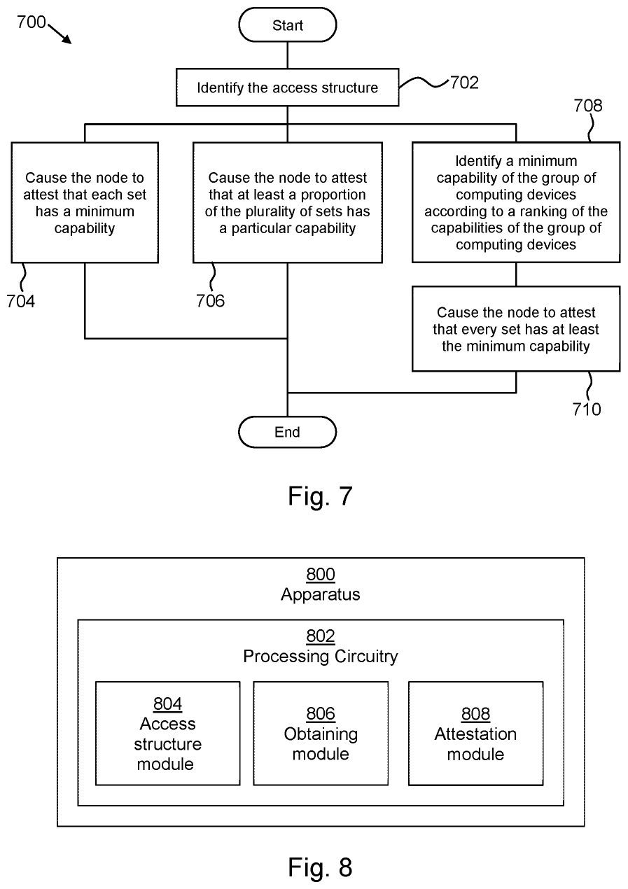

FIG. 7 depicts a flowchart of a method 700, which may be implemented as part of or in conjunction with the method 100 of FIG. 1 and/or the method 600 of FIG. 6. The method 700 may be at least partially implemented by a node associated with a plurality of computing devices (e.g., a client-side node). However, a network node such as a server associated with a remote party, such as described in the above examples, may in some examples at least partially implement the method 700.

The method 700 may comprise, in block 702, identifying the access structure comprising a plurality of sets selected from the group of computing devices. The attestation may comprise any capability which is shared by all sets. For example, the access structure may be determined by a group controller (e.g., one of the computing devices) based on a received policy (e.g., from the service provider), or the access structure may otherwise be known to the group controller, or be set by a user. The method may then proceed to any of block 704, 706 or 708. In some examples, just one or two of these options may be available in a given system.

In some examples, the method 700 may comprise, in block 704, causing the node (e.g., the group controller or other node associated with the user or client) to attest that each set has a minimum capability (e.g., a minimum user authentication capability). Where there are a plurality of sets, each of those sets may comprise computing devices with certain capabilities. In an example, the minimum user authentication capability may refer to a predetermined user authentication capability for accessing the service. For example, the computing devices, user or service may predetermine which user authentication capabilities are acceptable or unacceptable to access the service. The capabilities may be ranked according to some criteria, for example, the degree of trustworthiness that can be attributed to certain capabilities. The minimum capability may be the lowest ranked capability. By attesting to the minimum capability, it may not be necessary for every device within the group of computing devices to interact during the attestation procedure.

In some examples where the access structure comprises a plurality of sets selected from the group of computing devices, the attestation may comprise a plurality of capabilities associated with a likelihood that a set includes the capability. For example, the method 700 may comprise, in block 706, causing the node to attest that at least a proportion of the plurality of sets has a particular capability (e.g., a user authentication capability). The proportion may be indicative of the likelihood that a set includes the capability. For example, a 100% proportion is indicative that all sets have the capability. Similarly, a 60% proportion is indicative that 60% of the sets have the capability, and so on for other proportions. In some related examples, the attestation may include information regarding how many of the sets out of all of the sets have the particular capability. In other similar words, the access structure may define unions of capabilities identified from every set. An intersection of the unions may be identified where every single set has the particular capability common to each set. In another example, certain capabilities may not be in the intersection, in which case the method may attest to a proportion of the sets having the particular capability.

In an example related to block 706, the group of computing devices may comprise five computing devices denoted {A, B, C, D, E} andΓ is a threshold access structure with threshold t=3. In an example, A has two capabilities denoted {p1, p2}, B has three capabilities denoted {p1, p3, p4}, C has two capabilities denoted {p2, p5}, D has three capabilities denoted {p1, p4, p5} and E has one capability denoted {p6}. In the context of the particular capability, p1 may be a password, p2 may be a fingerprint reader, p3 may be facial recognition, and so on. Each set has the following capabilities (which is the union of the user authentication capabilities of all the devices in each subset): ABC={p1, p2, p3, p4, p5}, ABD={p1, p2, p3, p4, p5}, ABE={p1, p2, p3, p4, p6}, ACD={p1, p2, p4, p5}, ACE={p1, p2, p5, p6}. ADE={p1, p2, p4, p5, p6}, BCD={p1, p2, p3, p4, p5}, BCE={p1, p2, p3, p4, p5, p6}, BDE={p1, p3, p4, p5, p6} and CDE={p1, p2, p4, p5, p6}. The intersection of all these unions is the capability p1, meaning that every set within the minimal access structure (i.e., ABC, ABD, ABE, ACD, ACE, ADE, BCD, BCE, BDE and CDE) has at least one computing device having the capability of p1, and so p1 can be enforced in every set. Thus, in an example in which the sets are predetermined (in this example by specifying the threshold as being t=3), the attestation may be a declaration that the group has the capability or capabilities which can be provided by all the sets (i.e. in this example, the attestation could be an attestation of p1). The service provider may then determine whether p1 is sufficient for its purposes.

The capabilities that are not in the intersection could also be attested to with a percentage attached, indicating the likelihood that a set may provide a capability. So, for the above example, the group could attest to having capabilities: p1 100% of the time, p2 90% of the time, p3 60% of the time, p4 90% of the time, p5 70% of the time and p6 60% of the time, where the percentages are worked out with respect to the size of the minimal access structure. The service provider may then determine whether these percentages are sufficient for its purposes, and in some examples, this percentage information may be used to help guide a user towards using a certain combination of devices with an increased likelihood of being enforceable compared with the other sets. For example, the service provider may notify the user of the group of devices or sets which are likely to be capable of providing specified threshold capabilities.

In some examples, the method 700 may comprise, in block 708, identifying a minimum capability of the sets of devices with the group of computing devices according to a ranking of the capabilities (e.g., of the group of computing devices), where the attestation may comprise the minimum capability. The method 700 may comprise, in block 710, causing the node to attest that every set has at least the minimum capability. As described previously, capabilities may be ranked according to some criteria. In an example, it may be possible to rank the capabilities according to the degree of trustworthiness that can be attributed to certain user authentication capabilities. For example, a biometric identification system may be ranked higher than a password verification system. This ranking may be predetermined. Thus, in this example, if every authorized set has at least one computing device with password verification system capability, the attestation may include this information as the minimum capability. In some examples, a threshold number of computing devices could be established from a group of devices and the group could attest to having the capabilities of the lowest ranked computing device within the group according to the threshold. For example, in a group comprising five computing devices and a threshold number of three defined by a threshold access structure, the group could attest to having at least the capabilities of the third lowest ranked (or weakest) computing device in the group. The attestation may then be used to confirm that the attesting set has capabilities equal to or stronger than the capability of the lowest ranked computing device within the set. The service provider may then determine whether this particular set has capabilities which are sufficient for its purposes (e.g., the service provider may compare the attested capabilities with its DCP), and therefore may decide whether or not to accept the set.

In some examples, if the sets do not meet the criteria (e.g., as indicated by the DCP), the service provider may assess other combinations of computing devices, for example specifying minimum acceptable capabilities and allowing a user or client to form sets from the group meeting these capabilities.

FIG. 8 is a schematic illustration of an apparatus 800 for implementing certain methods described herein. The apparatus 800 may be implemented in a client-side node for providing the attestation as described in relation to the method 100, method 600 and/or method 700. For example, the apparatus may comprise a computing device at client-side such as described in relation to FIGS. 1 and 2 or be any node at client-side communicatively coupled to the computing devices. The apparatus 800 comprises processing circuitry 802. The processing circuitry 802 comprises an access structure module 804 to determine an indication of an access structure for a group comprising a plurality of devices. The processing circuitry 802 further comprises an obtaining module 806 to be communicatively coupled to a plurality of devices (e.g. computing devices), to obtain information regarding a capability (e.g., a security capability, which may be an example of a user authentication capability) of (e.g., each of) the plurality of devices. The processing circuitry further comprises an attestation module 808, to provide information relating to the capabilities of the group to a requesting party (e.g., a remote party such as a service provider) according to the access structure of the group.

In some examples, the access structure module 804 may, in use, determine the indication of the access structure according to a threshold policy (e.g., which may be set by a user) specifying a minimum capability (e.g., a minimum security capability) for a combination of computing devices selected from the plurality of devices. The minimum security capability may be an example of a minimum user authentication capability. The threshold policy may be determined by the user, the requesting party, or by the computing devices collectively, for example.

The apparatus 800 may be configured to carry out at least some of the blocks relating to a client-side method in FIG. 1, 6, or 7.

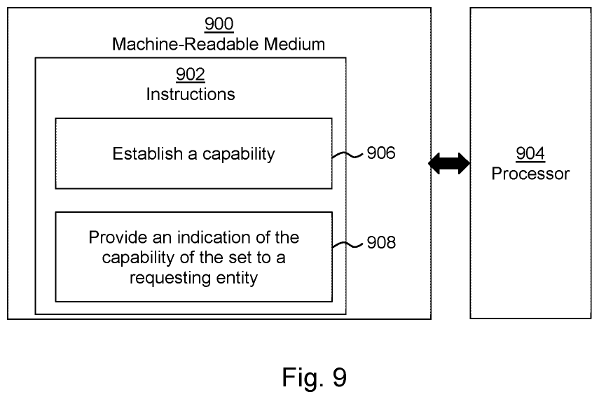

FIG. 9 schematically illustrates a machine-readable medium 900 (e.g., a tangible machine-readable medium) which stores instructions 902, which when executed by at least one processor 904, cause the at least one processor 904 to implement certain methods described herein. In some examples, the machine-readable medium 900 may be implemented in a client node.

The instructions 902 cause the at least one processor 904 to, in block 906, establish, for a group of at least two computing devices associated with a predetermined access structure defining a set within the group of computing devices, a capability (e.g., a security enforcement capability) of the set. The security enforcement capability may be an example of a user authentication capability and/or a security capability.

The instructions 902 cause the at least one processor 904 to, in block 908, provide an indication (e.g., an attestation) of the capability of the set to a requesting entity. The requesting entity may be an example of a remote party, service provider or a requesting party.

As set out above, the attestation may be provided before or after the set is established, and in some examples, the sets may be determined based on the attestation.

The instructions 902 may be configured to cause the processor(s) to carry out at least some of the blocks relating to a client-side method in FIG. 1, 6, or 7.

In some examples, where the predetermined access structure comprises a plurality of sets, the indication described above may identify a proportion of the sets having the capability with respect to the predetermined access structure. For example, a certain percentage of the sets may each have the capability. Where all of the sets have the capability, the indication may be indicative of there being an intersection of the unions of the capabilities of every set.

In some examples, the predetermined access structure described above may be determined by a user identification of combinations of computing devices from the group which meet a capability specification. For example, a user may identify the combinations of devices which meet a capability specification such as a threshold security enforcement capability. The threshold security enforcement capability may be an example of a minimum user authentication capability or a minimum security capability.

Examples described herein may be implemented at client-side (e.g. at a node communicatively coupled to the computing devices) or at server-side (e.g., at a network node associated with a remote party). Examples described herein in relation to a server-side method or apparatus may cause certain methods to be implemented at client-side, and vice versa. Thus, any example described in relation to a client-side method or apparatus may be at least partially implemented by, or caused by, a server-side method or apparatus, and vice versa. In an example, any reference to a user described herein may refer to a client.

Techniques described herein may have utility beyond user authentication. In an example, attestation procedures may be used to represent the collective state of a distributed system comprising a plurality of devices, which may be relevant for distributed processing applications such as rendering, web services, and the like.

Techniques described herein may have utility in terms of attesting to the capabilities of multiple components on a single platform such as a printer or PC, each of which may comprise a plurality of devices that collectively represent the state of the device. The confidence in an attestation provided by the platform may be strengthened by combining the attestations of the constituent components of the platform.

Examples in the present disclosure can be provided as methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine-readable instructions.

The machine-readable instructions may, for example, be executed by a general purpose computer, a special purpose computer, an embedded processor or processors of other programmable data processing devices to realize the functions described in the description and diagrams. In particular, a processor or processing apparatus may execute the machine-readable instructions. Thus functional modules of the apparatus (such as the access structure module 804, obtaining module 806 and/or the attestation module 808) may be implemented by a processor executing machine-readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine-readable instructions may also be stored in a computer readable storage that can guide the computer or other programmable data processing devices to operate in a specific mode.

Machine-readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims. Based on means based at least in part on.

The features of any dependent claim may be combined with the features of any of the independent claims or other dependent claims.

1. A method comprising;
requesting, from a node associated with a group comprising a plurality of computing devices associated with an access structure defining a set within the group of computing devices, an attestation of a capability of the set;
receiving the attestation; and
implementing, based on the received attestation, a procedure according to a device capability policy.

2. The method of claim 1, where the device capability policy is indicative of a specified procedure to be implemented based on a minimum capability of the set.

3. The method of claim 1, where the access structure is determined according to a threshold specifying a minimum capability fora combination of computing devices selected from the group, where the devices providing the minimum capability are defined as a set.

4. The method of claim 1, where the node is representative of a logical device comprising the set.

5. The method of claim 1, comprising causing a determination to be made as to whether a combination of devices within the set are co-operatively associated with each other, to provide the attestation with proof of the capability of the combination of devices within the set associated with the node.

6. The method of claim 5, where causing the determination to be made comprises causing each of the devices within the set to indicate, responsive to receiving a common challenge, that the combination of devices are co-operatively associated with each other.

7. The method of claim 5, where causing the determination to be made comprises causing a first device of the combination of devices to provide, responsive to a statement generated by a second, different, device of the combination of devices attesting to a capability of the second device, an indication that the first device has signed the statement from the second device.

8. The method of claim 5, where causing the determination to be made comprises causing the combination of devices to collaboratively produce a statement attesting to the capability of the combination of devices.

9. The method of claim 1, where the access structure comprises a plurality of sets selected from the group of computing devices, and where the attestation comprises any capability which is shared by all sets.

10. The method of claim 1, where the access structure comprises a plurality of sets selected from the group of computing devices, and where the attestation comprises a plurality of capabilities associated with a likelihood that a set includes the capability.

11. The method of claim 1, where the access structure comprises a plurality of sets selected from the group of computing devices, the method comprising identifying a minimum capability of the sets of devices within the group of computing devices according to a ranking of the capabilities, where the attestation comprises the minimum capability.

12. The method of claim 1, where implementing the procedure comprises determining a service level based on a comparison between the received attestation and the device capability policy.

13. Apparatus comprising processing circuitry, the processing circuitry comprising:
an access structure module to determine an indication of an access structure for a group comprising a plurality of devices;
an obtaining module to be communicatively coupled to a plurality of devices, to obtain information regarding a capability of the plurality of devices; and
an attestation module, to provide information relating to the capabilities of the group to a requesting party according to the access structure of the group.

14. A tangible machine-readable medium storing instructions, which when executed by at least one processor, cause the at least one processor to:
establish, for a group of at least two computing devices associated with a predetermined access structure defining a set within the group of computing devices, a capability of the set; and
provide an indication of the capability of the set to a requesting entity.

15. The tangible machine-readable medium of claim 14, where the predetermined access structure is determined by a user identification of combinations of computing devices from the group which meet a capability specification.
